(19) United States
(12) Patent Application Publication
(10) Pub. No.: US 2020/0202382 A1
(43) Pub. Date: Jun. 25, 2020

(54) SYSTEM AND PROCESS TO DETERMINE THE CAUSAL RELATIONSHIP BETWEEN ADVERTISEMENT DELIVERY DATA AND SALES DATA

(71) Applicants: Yan Ping Chen, Chicago, IL (US); John Clifton Davis, Seattle, WA (US); Antonio Hudson, Chicago, IL (US); Alex Chin, Stanford, CA (US)

(72) Inventors: Yan Ping Chen, Chicago, IL (US); John Clifton Davis, Seattle, WA (US); Antonio Hudson, Chicago, IL (US); Alex Chin, Stanford, CA (US)

(21) Appl. No.: 16/225,586

(22) Filed: Dec. 19, 2018

(51) Int. Cl. G06Q 30/02; G06N 20/00

(52) U.S. Cl. CPC G06Q 30/0243; G06N 20/00; G06Q 30/0201; G06Q 30/0246

(57) ABSTRACT

A system and process to determine the causal relationship between advertisement delivery data and sales data are disclosed. According to one embodiment, a method comprises importing advertisement data and sales data. The advertisement data and the sales data are joined to generate a joined data set. Customer journeys are generated for a timeframe from the joined data set. A first group of customers who saw an advertisement of interest are identified. A second group of customers who did not see the advertisement of interest are identified. Each customer of the first group is matched to a customer in the second group who is similar to the customer of the first group. An average treatment effect for the advertisement of interest is calculated.

### FIELD

The present disclosure relates in general to the field of computer software and systems, and in particular, to a system and process to determine the causal relationship between advertisement delivery data and sales data.

### BACKGROUND

Attribution modeling tries to answer the question of which initiatives actually cause particular business outcomes—it attributes business success to the individual initiatives your company does. For marketing in particular, attribution uses statistical techniques to tie specific marketing activity and other customer interactions to conversions, clicks, or sales. Conveniently, attribution modeling saves time and money because it leverages already available data, unlike a randomized controlled trial (A/B test). When attribution modeling is done right, it tells you how much business impact you get due to each choice you make, and enables you to optimize resources based on which of those choices are most effective.

Historically, media agencies, Facebook, and other organizations have used simple methods to answer the question of which advertisements work (e.g., “first touch”, “last touch”, and “linear touch” attribution). FIG. 1 illustrates traditional attribution processes.

As illustrated in FIG. 1, A, B, and C are different advertisements that a single customer sees. In first touch attribution, all of the credit for the purchase goes to the first ad—so B gets all of the credit—assuming that the first advertisement someone sees is what causes them to make the purchase. In last touch attribution, all of the credit for the purchase goes to the last ad—so C gets all the credit, assuming it's the last advertisement someone sees is what causes them to make a purchase. In linear touch attribution, credit is assigned proportionally to each ad—so B gets 50% of the credit, and A and C each get 25% of the credit for conversion.

Prior attribution processes only measure total sales when you use that method—but they do not tell you how much sales increased because you used that ad or method. There are at least two problems with prior attribution processes:
1. They make faulty assumptions about why people buy something
2. They measure success wrong
   With respect to faulty assumptions, a decision to purchase something is not usually caused by seeing an advertisement once and that only the last ad a person sees affects their purchase behavior. Because of this faulty assumption, the models are inherently biased toward high volume advertisement campaigns because it is just more likely that the last advertisement seen came from a high volume campaign (e.g. if $5 million is spent on campaign A and only $1 million on campaign B, then it is 5× as likely that the last ad seen comes from campaign A). In effect, it does not tell you an ad is good or bad, but just tells you that you spent more money on ads for that campaign. It is likely also not just dependent on volume of advertising—there are plenty of advertisements we see many, many times without ever buying anything—and seeing one of those ads last by coincidence does not matter. However, with first touch, last touch, and linear touch, both of these assumptions are built in. If assumptions are made that are not based on reality, the wrong answer results.

Also with respect to faulty assumptions, prior attribution processes make assumptions about how people behave, “only the last ad a person sees affects their purchase behavior.” Because prior attribution processes make this assumption, prior attribution processes will always be inherently biased toward high volume ad campaigns because it is just more likely that the last ad you seen by a viewer came from a high volume campaign. For example, if you spent $5 million on campaign A and only $1 million on campaign B, then it is 5× as likely that the last ad a viewer sees comes from campaign A, which means that given your assumptions, it will inherently be biased toward campaign A, the high volume campaign. In effect, these prior attribution processes do not determine if an ad is good or bad, but just indicates that you spent more money on ads for that campaign.

The measurement of success can be explained when considering two campaigns—one targeted towards your highest volume customers, and the other targeted at only occasional buyers. There are two ways to measure success. The first asks the simple question, “How many sales did I make when I ran this campaign?” By this measure, you are probably going to say that the campaign targeted at high volume customers is better—they bought more. There were clearly more sales for people targeted by the high volume campaign than the low volume campaign. According to traditional measurement methods, this means the high volume campaign was better. But that campaign had more sales because it was targeted specifically towards customers who were always going to buy more. The prior attribution processes do not address this problem of ads that target a specific audience that may already be more receptive to the advertised product and thus have a higher estimated probability of conversion.

A better question to ask is, “How many more sales did I make because of this campaign?” For this, you have to compare how many sales you did make to how many sales you would have made without that campaign. For this, you separately look at the high and low volume customers. What you will see is that for both the high volume and low volume customers, the ad increased sales. However, the increase was much more significant for the low volume customers—sales for low volume customers who saw the ad were nearly double than customers who did not see the ad. The return on investment for the ad for low volume customers is much better—and so you should grow your investment here.

Sometimes with prior attribution systems, they are unable to differentiate between the message and the medium, e.g. online videos and online display ads may look the same in the data, but the mediums may impact the effectiveness of the message.

In digital advertising, it is common to see only a handful of conversions per ten-thousand impressions. This puts many attribution problems firmly in the realm of rare event modeling. Because popular modeling techniques are often unreliable when the number of positive examples (i.e. conversion) is this low, naive models can easily lead to inaccurate results.

Digital ad datasets often consist of billions of records. Prior attribution models have to be implemented at this scale in order to be useful. There are many sophisticated prior attribution models which cannot be used due to their high computational footprints.

For each user, with prior attribution processes observe many marketing events per outcome (e.g. a user sees 17 ads on an ecommerce domain before making a purchase). With prior attribution processes, the connection between each impression in this journey and the purchase depends on assumptions about how marketing events influence behavior. It is often the case in practice that different attribution models produce different and contradictory results about the relative success of ad campaigns of interest. In other words, prior attribution models are not robust to model misspecification.

### SUMMARY

A system and process to determine the causal relationship between advertisement delivery data and sales data are disclosed. According to one embodiment, a method comprises importing advertisement data and sales data. The advertisement data and the sales data are joined to generate a joined data set. Customer journeys are generated for a timeframe from the joined data set. A first group of customers who saw an advertisement of interest are identified. A second group of customers who did not see the advertisement of interest are identified. Each customer of the first group is matched to a customer in the second group who is similar to the customer of the first group. An average treatment effect for the advertisement of interest is calculated.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying figures, which are included as part of the present specification, illustrate the various embodiments of the presently disclosed system and method and together with the general description given above and the detailed description of the embodiments given below serve to explain and teach the principles of the present system and method.

FIG. 1 illustrates traditional attribution processes.

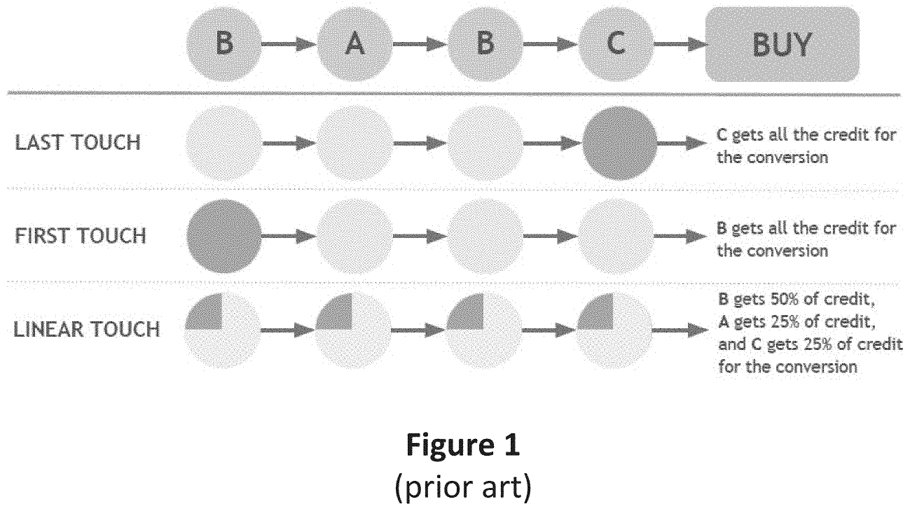

FIG. 2 illustrates an exemplary match attribution process, according to one embodiment.

FIG. 3 illustrates an exemplary match attribution system, according to one embodiment.

FIG. 4 illustrates an exemplary match attribution process to generate advertisement performance data, according to one embodiment.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

A system and process to determine the causal relationship between advertisement delivery data and sales data are disclosed. According to one embodiment, a method comprises importing advertisement data and sales data. The advertisement data and the sales data are joined to generate a joined data set. Customer journeys are generated for a timeframe from the joined data set. A first group of customers who saw an advertisement of interest are identified. A second group of customers who did not see the advertisement of interest are identified. Each customer of the first group is matched to a customer in the second group who is similar to the customer of the first group. An average treatment effect for the advertisement of interest is calculated.

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Attribution modeling is the collection of techniques used to tie business outcomes to specific marketing events. The core business question addressed by these techniques is the following: given several ad exposures, or impressions, along a user's journey, what is the relative contribution of each impression to the user's purchase? Often marketing efforts lack data-driven metrics that reliably answer this question and are often justified by proxy metrics such as click-through-rate (CTR) or simplistic attribution models with known issues.

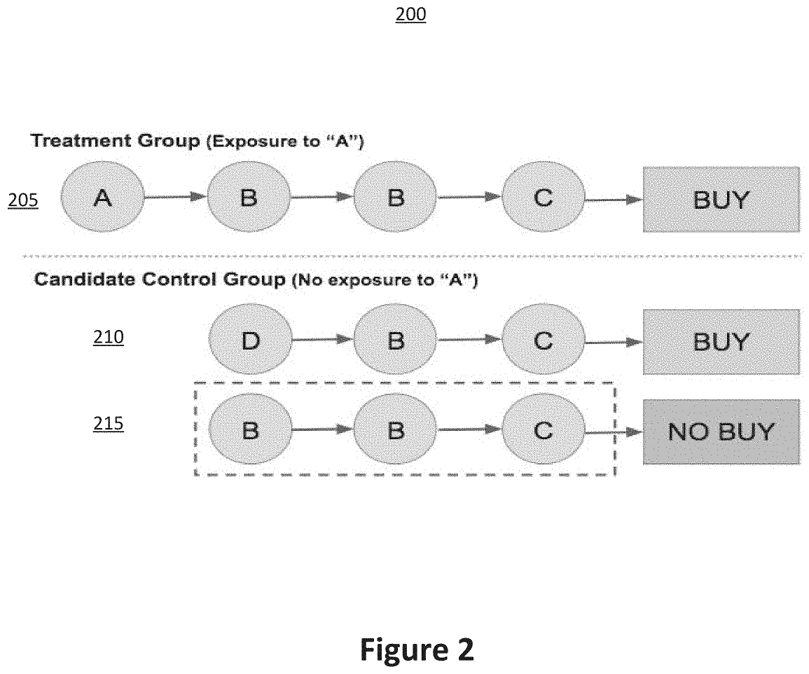

FIG. 2 illustrates an exemplary match attribution process 200, according to one embodiment. Here, in this simplified example, there are three customers, 205, 210, 215. Match attribution process 200 answers the question of whether ad A is effective. Match attribution process 200 finds that customer 205 has seen ad A, and assigns customer 206 to the first group (the treatment group). Then process 200 looks at all the people who did not see ad A. In this example there are two people customer 210 and customer 215 who did not see ad A. Of these two people, customer 210 is more similar to customer 205 (because they both share the journey of advertisements B-->B-->C). As a result, customer 210 is matched to customer 205 and is added to the second group (control group). Those two customers 205 and 215 are a match, meaning that they can be compared because they are mostly identical, except for the thing to be measured, ad A.

This idea of matching works whether the customer has seen one ad or a hundred, are a high volume customer or have never bought anything—the only thing that matters is that there are two people who look similar, except for one difference—the thing to be measured. Process 200 uses models to find the most similar looking people, as described above.

The present match attribution process 200 measures backlash and causality, which prior attribution methods do not accomplish. Backlash occurs when a customer sees the advertisement, and then buys less than they otherwise would. Process 200 captures backlash because it measures causality. Process 200 is able to measure causality because it uses similarity matching. These derive from one another. Because prior attribution processes do not perform matching, they do not determine backlash (e.g., if you don't compare two groups, you cannot tell when one does worse than the other, and definitely can't tell if a group buys less than they would after they see your ad.)

Causality is equally important because prior attribution processes just determine what happened when an advertisement was shown. The present attribution match process 200 determines that the advertisement did actually cause what happened (e.g., a purchase). The present match attribution process 200 compares two people who are otherwise similar.

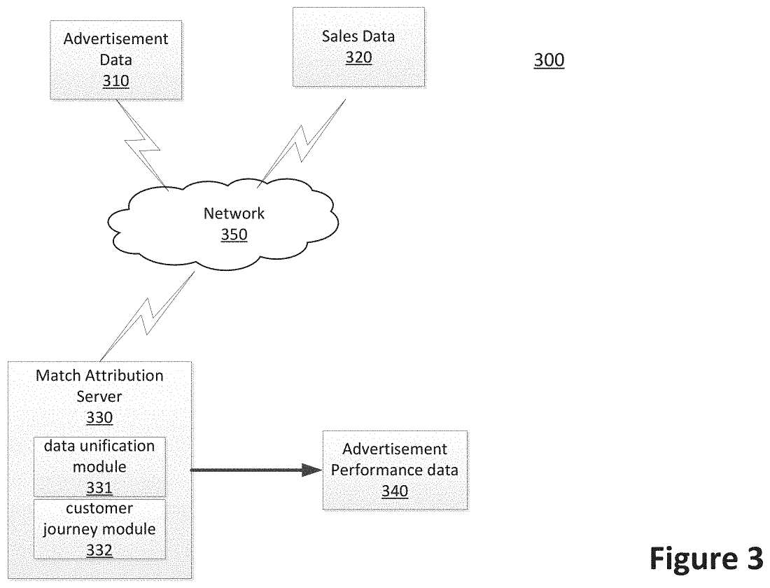

FIG. 3 illustrates an exemplary match attribution system 300, according to one embodiment. Match attribution system 300 includes advertisement data 310 and sales data 320. Match attribution server 330 accesses advertisement data 310 and sales data 320 through network 350, which may be the Internet or other computing network. Match attribution server 330 includes a data unification module 331 to link digital advertising data 310 (e.g., a chronological list of marketing activities during a particular time period, etc.) to sales data 320 (e.g., click-thrus, sign-ups, sales and/or other outcome data, conversions, etc.). Match attribution server 330 also includes a customer journey module 332 that uses the unified advertisement and sales data to create advertisement exposure paths for customers. Ultimately, match attribution server 330 generates advertisement performance data 340, including the estimated incremental effect of an advertisement on conversion, how many people converted with a particular advertisement and (e.g., determining the conversion rate), and the proportion of conversion between if an advertisement is shown or not shown, as well as one advertisement's effectiveness versus another advertisement's (e.g., one advertisement changes more minds than another).

Advertisement performance data 340 may be a ranked list of advertisements based on their performance (e.g., highest proportion of conversion). Match attribution system 300 may also consider data such as linked demographic and broader sales data and data about the content and methods of the advertisement. The advertisement performance data 340 allows for improved marketing decisions than data from prior attribution systems where companies can decide to drop the least effective advertisements and buy more advertisement impressions for top performing advertisements.

Advertisement data 310 may include a user ID, and advertisement ID and an impression date and time. Sales data 320 may include a user ID, a product IP and a sales date and time. Data unification module 331 joins the advertisement data 310 with sales data 320 to generate an impression-level table, including matching a customer's activities between devices and the customer's offline activities. Customer journey module 332 uses the impression level table to generate customer journey data that has a sequence of advertising events that lead to a conversion (e.g., a purchase, or no purchase). Match attribution server 330 uses the customer journey data with a match attribution process to generate the advertisement performance data 340. The present system assumes a time window (e.g., fixed or variable) and a single end-of-window response variable taking the value 1 if the customer converted at some point during the window and 0 otherwise. According to alternate embodiments, the value does not have to be 1 or 0, but could be any value, e.g. dollars spent.

For each customer, the time series of advertisement exposures or impression history is recorded. This includes a list of increasing timestamps, and for each, information about the impression, such as domain name or creative/advertisement ID.

Match attribution system 300 includes:
Models that measure the incremental causal impact of ad campaigns;
Models can measure backlash; and
Models can measure diminishing return effects and memory decay effects.

Match attribution system 300:
Can measure on binary outcomes (e.g., 0/1—did a person buy this thing?) and also continuous outcomes (e.g., how much money did they spend?).
Can measure different kinds of outcomes—clicks, purchasing items, response on a survey, etc.
Can measure impact on different measurement categories—campaign id, ad id, site partner, audience, etc.
Can roll up ad effects from lower categories to higher level categories—ad ids can roll up to campaign level.

Match attribution system 300 provides an end-to-end workflow that ingests outcome data (from sales, surveys, etc.) and digital impression data, joins them together and processes them, runs attribution models on them, and returns incremental causal impact in the form of a report or feed to a frontend application.

Match attribution system 300 automatically runs models on each ad for many ads (hundreds, thousands) in parallel (spin up many machines in the cloud (to increase the speed of analysis)).

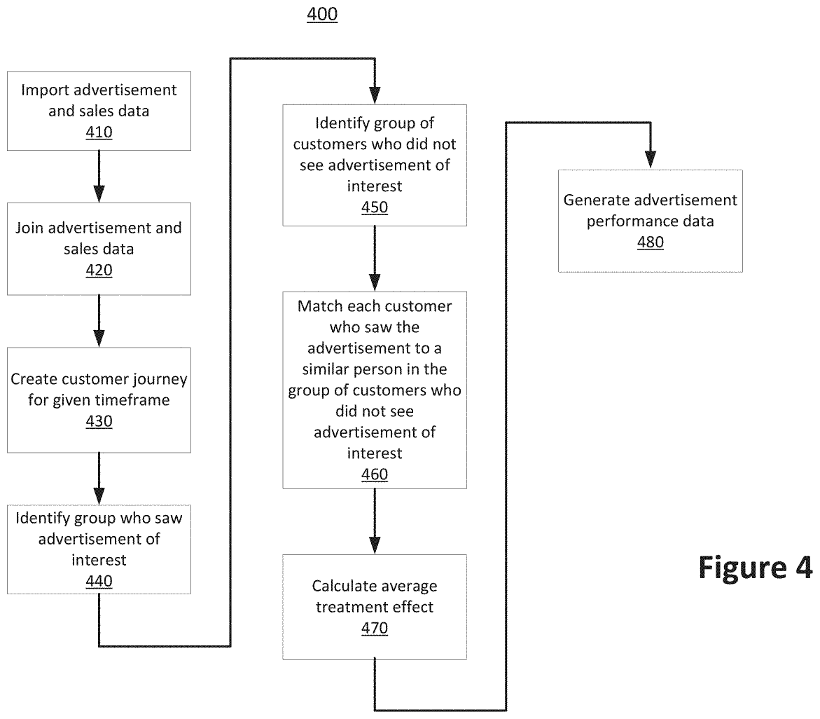

FIG. 4 illustrates an exemplary match attribution process 400 to generate advertisement performance data, according to one embodiment. Process 400 is repeated hundreds of times because there are often hundreds of advertisements that the system analyzes. Match attribution server 330 imports advertisement data (e.g., digital advertisement impressions, with data on impression timestamp, user id the advertisement was served to, associated campaign ID, etc.) and sales data (e.g., data on activities that occur post click or post view, activity-level with data on activity timestamp, user ID doing activity, activity type, conversion information, etc.) (410).

Match attribution server 330 and specifically, data unification module 331 joins the advertisement data and the sales data (420). For a given timeframe, customer journey module 332 rolls up (e.g., time sequences) the joined data to a user level, determining each customer's conversion outcome and full customer journey over the given timeframe (430). For a given user ID in a given time frame the following information is analyzed:
customer ID/cookie ID
total number of impressions the user was exposed to in time frame
outcome—whether or not user converted in time frame, i.e. had at least one sale, “New Service Agreement” or “Add a Line” activity
if outcome is positive, the first instance of a conversion in time frame, if outcome is negative value is NULL
the user journey in time frame, a list of campaign codes that the user was exposed to in the time frame in chronological order
the timestamps of the user journey in the time frame, a list of timestamps for ad exposures associated with a campaign ID, also in chronological order
subset of campaign codes that occurred prior to a conversion, e.g., the subset of the user journey that occurred prior to conversion
subset of the list of timestamps for ad exposures prior to conversion, e.g., the timestamps associated with the subset of campaign codes

From the joined data set, match attribution server 330 identifies a group of customers who saw the advertisement of interest (440). From the joined data set, match attribution server 330 identifies a group of customers who did not see advertisement of interest (450). Match attribution server 330 matches each customer who saw the advertisement to a similar person in the group of customers who did not see advertisement of interest (460). Match attribution server 330 calculates the average treatment effect by finding the difference in average outcomes between customers who saw the ad and those in the matched group (470). Finally, match attribution server 330 generates advertisement performance data (480).

A causal inference process relies on matching to estimate the treatment effect of advertising campaigns. Broadly, the present system matches users above a certain exposure threshold (e.g. saw at least one ad from campaign “A”) to users below that threshold on the basis of their exposure to other creatives and auxiliary information such as demographics. The high-exposure group defines a pseudo-treatment group, and the matched low-exposure group defines a pseudo-control group. The estimated effect of the increased exposure is calculated as the difference in the conversion proportion between the treatment and control groups.

The present system may use any of the following matching processes: impression counts, time independent; path dependent; and path and time dependent processes. In other words, match attribution server 330 may execute any of the matching processes below to generate advertisement performance data 480. As described in greater detail below, each of the processes below have different data structures. In addition, the processes below may use different statistical matching models—propensity matching, inverse probability weighting, or optimal matching using linear sum assignment. It can also use methods from double/debiased machine learning to directly estimate the causal parameters, etc.

Impression Counts, not Time Dependent:

The present system matches users based on the total number of impressions of each campaign they have seen. In other words, the order of the user path will be irrelevant. Users above an exposure threshold for campaign, like A, will be matched to users below that threshold for A on the basis of the total number of impressions for campaigns B, C, and so on. Matching is performed using propensity matching, inverse probability weighting, and optimal matching via linear sum assignment. The present system ensures that the pseudo-treatment and pseudo-control groups are as comparable as possible. This process also imposes no assumptions about the relationship between impressions and conversions and thus is completely data-driven.

In one embodiment, if we are interested in campaign A and the system is using a threshold of two (e.g., saw at least two ads in a campaign to be considered “treated” for that campaign), then user path A-A-B-C and A-A-B-B-C would both be considered treated for campaign A, since A shows up at least twice in both paths. Then the system considers the non-A's in the path. For A-A-B-C, you have {B: 1, C: 1} and for A-A-B-B-C, you have {B: 2, C: 1}. For every user who is treated, the system matches them with a user who is not treated. For example, a user path A-A-B-C may be matched to user paths A-B-C or B-C, since their paths include {B: 1, C: 1}. The present system performs this for every person who is treated to generate a treated group and a corresponding matched control group. The system then finds the difference in conversion rates between the treatment and pseudo-control groups to find campaign A's average treatment effect.

Path Dependent:

The impression counts process described above treats a user path B-B-A-C and C-A-B-B as identical, since it is only concerned with the total number of impressions per campaign. In a path dependent process, the present system assumes that the order in which a user sees ads affect their effectiveness. For this process, the system matches pseudo treatment and controls using the full user path, in the order in which it occurred. For example, for target ad “A”, the system may select user path B-B-A-C as the pseudo-treatment user for a pseudo-control user path B-B-C. Similar to the impression counts process described above, once the system uses matching to create the treatment and pseudo-control groups, the system then finds the difference in conversion rates to measure the average treatment effect of the advertisement.

Path and Time Dependent:

Similar to the path dependence process, the present system matches based on the order in which a user is exposed to advertisements, but also the amount of time between each advertisement exposure. For example, a user path B-B-A-C may all have occurred within five minutes, but another user path B-B-A-C may have occurred across 30 days. This process treats these two user paths differently in the matching process to create pseudo treatment and control groups.

Markov Model Process:

Suppose three campaigns given by A, B, and C. For each user path, match attribution server 330 computes the number of times a user went from path A to B, C to A (e.g. compute all pairwise jumps). Match attribution server 330 also computes the number of jumps such as B to “no conversion” or C to “conversion”. This implicitly generates a Markov process with 5 states: A, B, C, “no conversion”, and “conversion”. Match attribution server 330 also compute the probability of each initial state by computing the number of times a user path starts with A, B, and so on. This effectively trains a first order markov process which generates user-paths. To compute the effect of campaign B, match attribution server 330 forces all paths that cross B to move directly to “no conversion”. Match attribution server 330 simulates many sample user paths from this reduced model with B removed, and computes the fraction of chains that end in conversion. When this fraction is very small, B is more important for conversion (because very few paths ended in conversion without the presence of B).

Memory Process Models:

With a memory process model, match attribution server 330 assumes that people forget ads like e\hat{ }(−1×“time since they saw the ad”). Match attribution server 330 computes the time since the impression for each user and then computes the memory decay in the exponential function. For each ad impression, match attribution server 330 treats this decay as the weight. Match attribution server 330 computes the share of the overall weight by campaign.

As stated above, matching may be performed using propensity matching, inverse probability weighting, and optimal matching via linear sum assignment. These observational causal inference models are applied to static-time data rolled up to the user-level.

According to one embodiment, the present system uses an Optimal Match Model that uses nonparametric matching to construct a pseudo-control group. Then, the present system compares the conversion rate of the exposed units to the pseudo-control group's conversion rate.

According to another embodiment, the present system uses a Propensity Match Model that uses parametric matching to construct the pseudo-control group. Otherwise, this estimator is similar to Optimal Matching.

According to another embodiment, the present system uses an Inverse Probability Weighting model that reweights the estimated ATE based on the inverse of the propensity score. This estimator does not use matching; instead, it uses a weighting technique to account for the nonrandom treatment assignment (i.e. the fact that some users are more likely than others to receive certain advertisements).

According to another embodiment, the present system uses a Double Machine Learning model provides a regression-based estimator using a two-stage procedure: (a) first train a response model and treatment propensity model using machine learning algorithms, and (b) run linear regression on the out-of-sample residuals. This model is also based on observational causal inference. This is also applied to static-time data rolled-up to the user-level.

The Double Machine Learning model operates as follows. There are two estimates performed by the system: (a) estimating average treatment effects, and (b) estimating heterogeneous treatment effects. In both cases the present system estimates the requisite causal effects using meta-algorithms that are built on top of trained Machine Learning models.

We suppose we have observed n i.i.d. instances of the random tuple (Y, X, W), labeled (Y₁, X₁, W₁), . . . , (Yₙ, Xₙ, Wₙ). The tuple consists of a response variable Y, a factor variable W∈{(0,1} representing a (non-randomly assigned) binary treatment, and contexts/covariates

X∈R^{p}. The outcome Y is often a binary event (e.g. a conversion) but could also be real valued. Labeling the two treatment levels 0 (“control”) and 1 (“treatment”), the existence of potential outcomes Yᵢ(0) and Yᵢ(1) represent the outcomes for unit i that were observed, had the treatment assignment been Wᵢ=0 or Wᵢ=1, respectively. The observed outcome is:

Yᵢ=Yᵢ(Wᵢ)=WᵢYᵢ(1)+(1−Wᵢ)Yᵢ(0).

The average treatment effect (ATE) is represented as:

τ=E[Y(1)]−E[Y(0)].

The conditional average treatment effect (CATE) is represented as:

\hat{τ}(x)=E[Y(1)−Y(0)|X=x].

The process for obtaining \hat{τ} is:

1. Split the dataset into K pieces as you would cross-validation.
2. For every fold k:
Set aside observations in fold k as the test set, and use the remaining observations as the training set.
Use any ML algorithms to train predictive models for the outcome (Yᵢ on Xᵢ) and the propensity (Wᵢ on Xᵢ).
Use the fitted models to obtain predictions \hat{m}(Xᵢ) and ê(Xᵢ) for observations i in the test set (the k-th fold)
   3. Compute the residuals \hat{R}ᵢ=Yᵢ−\hat{m}(Xᵢ) and Ŝᵢ=Wᵢ−ê(Xᵢ). These represent the outcome and treatment where the effect of X has been removed.
   4. Do an OLS regression of \hat{R}ᵢ on Ŝᵢ, interpreting the coefficient and corresponding standard error as valid estimates of \hat{τ}.

Heterogenous treatment effects are estimated by the present system, as well. The goal is to justify using machine-learned values \hat{m}(⋅) and ê(⋅) as surrogates for m(⋅) and e(⋅) in the optimization:

$$\hat{τ} ( \cdot ) = {argmin}_{τ} \{ \frac{1}{n} {\sum }_{i = 1}^{n} {( ( {Y}_{i} - m ( {X}_{i} ) ) - ( {W}_{i} - e ( {X}_{i} ) ) τ ( {X}_{i} ) )}^{2} + {A}_{n} ( τ ( \cdot ) ) \} ,$$

The present system uses sample splitting: ê⁻ⁱ(Xᵢ) and \hat{m}⁻ⁱ(Xᵢ) are predictions of the Machine Learning models; e.g., predictions made without using the i-th training example. Then the plug-in objective is solved:

$$\hat{τ} ( \cdot ) = {argmin}_{τ} \{ \frac{1}{n} {\sum }_{i = 1}^{n} {( ( {Y}_{i} - m ( {X}_{i} ) ) - ( {W}_{i} - e ( {X}_{i} ) ) τ ( {X}_{i} ) )}^{2} + {A}_{n} ( τ ( \cdot ) ) \}$$

One advantage of this meta-learning approach is that the three functions (the outcome model, the treatment propensity model, and the residual model) are each handled by separate Machine Learning fits. This means that the models are configured for the complexity of the particular surface. For example, the outcome and propensities may be best predicted using boosting or a random forest, but given these predicted values, the optimal treatment effect fit might be obtained using a simple lasso.

According to another embodiment, the present system has a Survival Model that uses impression-level data to estimate time decay and diminishing marginal returns, as well as, ad effects based on a Bayesian survival analysis model trained using variational inference. This is a time series model that considers the time-series structure of the data. Both conversion and non-conversion are recorded as events by the present system, meaning that timestamps for both conversions and non-conversions are created. This is the case because the conversion events are obtained as survey responses (e.g. whether you indicate you will vote Democrat or Republican). A predictive model is trained to predict whether you convert, making sure to encode time-specfic and ad-specific features in a way that captures the desired estimands.

Our notation is as follows:
u represents a user and a represents an ad.
aᵤ, is the ad id of the ith ad seen by user u.
tᵤ, is the timestamp of the ith ad seen by user u.
cᵤ is the time of survey response.
nᵤ is the total number of impressions seen by user u.
yᵤ is the binary indicator of whether user u converts or not.

Note that yᵤ is treated as binary e.g., yᵤ is Bernoulli with user-specific conversion probabilities pᵤ=logit(hᵤ), where hᵤ=hᵤ(t) is the score assigned to user u who has taken a survey at time t.

To model the scores hᵤ, hᵤ(t) is a linear combination of various ad effects:

$${h}_{u} ( t ) = {β}_{0} + {\sum }_{□} \underbrace{{θ}_{□}}_{□} \underbrace{{e}^{- δ \cdot ( t - 1 )}}_{□} \underbrace{exp \{ - {γ}_{□} ( t - {t}_{□} ) \}}_{□} . \text{?}$$

$$\text{?} \text{indicates text missing or illegible when filed}$$

The parameters are as follows:
B₀ is an intercept. It is interpreted as a baseline conversion rate for someone who has seen no ads (once transformed into probability space)
ϑₐ is the main ad effect for creative a. It is interpreted as the instantaneous effect of conversion of seeing ad a, immediately after the ad is shown.
δ is the diminishing returns effect. When a user sees the _first ad, i=1, there is no penalty e^{-δ(i-1)}=1. For the second ad, i=2, there is a multiplicative penalty of e^{-δ}; for the third ad, i=3, a penalty of e^{-2δ}, and so on.
γₐ is the time decay effect of creative a. Note that cᵤ−t_{u,i} is the time lag between the impression event and the conversion event.

Given impressions training data and parameters, the present system computes the feed-forward pass of the scores and use that to generate conversion rates and then conversions.

The present system uses a function form similar to hᵤ(t) as defined above as the hazard rate. In other words, the present system parametrizes the impression data and uses the scores as a hazard rate rather than as input to a logistic regression. The hazard function is:

$${h}_{u} ( t ) = {\sum }_{□} {θ}_{{a}_{□}} {e}^{- δ \cdot ( t - 1 )} {e}^{- {γ}_{□} ( t - {t}_{i} )} . \text{?}$$

$$\text{?} \text{indicates text missing or illegible when filed}$$

The survival function is:

$${S}_{u} ( t ) = exp \{ {\sum }_{□} \frac{{θ}_{□} {e}^{δ \cdot ( t - 1 )}}{{γ}_{□}} [ {e}^{- {γ}_{□} ( t - {t}_{□} )} - 1 ] \} . \text{?}$$

$$\text{?} \text{indicates text missing or illegible when filed}$$

According to one embodiment, the present system samples a survival time Tᵤ from the survival density _ϕᵤ(t)=hᵤ(t)Sᵤ(t). If Tᵤ<tₘₐₓ, then the user is said to have converted during the time window, and Yᵤ=1. If Tᵤ≥_tₘₐₓ, then the user did not convert, and Yᵤ=0.

According to another embodiment, the present system uses a combination of the Double Machine Learning model and Survival Model. The present system takes advantage of the causal framework in the Double Machine Learning and the time-series impacts in the Survival Model:
Stage 1: Use the Survival Model to predict the target outcome
Stage 2: Develop a time-series model (with diminishing return and memory decay) to predict treatment
Stage 3: Build a model using the residuals from the Stage 1 and Stage 2 models to find treatment effects

The present system addresses the seasonality confounders in a time series causal attribution model described above. The present system may use a weighting system to address the biases between a sample of people exposed to advertisements to the US population using demographic data.

According to another embodiment, the present system connects multi-channel attribution modeling with media/marketing mix modeling to create a unified framework for marketing measurement and optimization. The present system may also be used to provide real-time updates to attribution modeling measurements and serve ads in real-time based on updated attribution measurements.

The present system may be part of a marketing optimization software suite. The suite includes all advertising measurement and optimization, from product and channel budget allocation for optimized performance to weekly performance and fine-tuning optimization. The suite allows integration of finance, CRM, and marketing data for a complete tracking and optimization ecosystem.

The present system is capable of:
Measuring performance so you can make tactical weekly decisions across paid and owned media
All the KPIs: Online, instore, 3rd party conversions (CPG) on television (Networks), surveys
Run tests across channels so you can understand impact of new products/tactics
Understand the impact your ads have on your performance, regardless of where they are running (screw the walled gardens)
Understand the effects your ads have across your brand
Control frequency and sequencing across platforms so you know how you are engaging with customers
Meet customers where they are at, across channels, so you can keep the engagement (cover 80% of touch points across channels)
Estimate the impact of future ads/creatives based on their similarity to existing creative
Allocate budgets across products/markets/channels optimally

Integrate with Data Platforms

The present system may be used with a web-based application that automatically ingest and processes data, runs attribution models (using methodologies described above), and reports the results.

As described above and in summary, match attribution server 330 performs the following:

ETL for Preprocessing Data
For a given timeframe, roll up impression-level data to the user level
Roll up impression-level data to create a data path of impressions for each user
If a positive outcome occurred in the data path, find the subset of the data path that occurred prior to the outcome
Append outcome data to the user-level impression data
Append information about the user—demographic features, historical purchases, etc.
Optional: downsample users with negative outcomes

Build Attribution Model Using Matching
Import an arbitrary user-level dataset with outcome and user path data
Create a user by campaign matrix of total ad viewership
For each campaign, iteratively match on user path, excluding campaign of interest
For each campaign, match attribution server 330 finds the average treatment effect (ATE) using pseudo-treatment and pseudo-control groups outputted from matching

### Validation

To validate that the present system generates valid advertisement performance data, match attribution server 330 analyzes the treatment effects outputted from attribution processes. Match attribution server 330 computes the standard error (SE) of the estimated average treatment effect (ATE) from the matching process. Then, match attribution server 330 computes the 95% (pseudo-)confidence interval of the average treatment effect. If it contains 0, then there is not strong evidence that the ad campaign has an effect.

Match attribution server 330 uses a sensitivity test on the average treatment effects. The sensitivity test computes the pvalue that the estimated ATE is nonzero as a function of how badly the RCT assumptions deteriorate. If the resulting pvalues are small, there is more evidence that the ad campaign has a nonzero effect on conversion.

While the present disclosure has been described in terms of particular embodiments and applications, summarized form, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the scope of the present disclosure.

What is claimed is:

1. A method, comprising:
importing advertisement data and sales data;
joining the advertisement data and the sales data to generate a joined data set;
creating customer journeys for a timeframe from the joined data set;
identifying a first group of customers who saw an advertisement of interest;
identifying a second group of customers who did not see the advertisement of interest;
matching each customer of the first group to a customer in the second group who is similar to the customer of the first group; and
calculating an average treatment effect for the advertisement of interest.

2. The method of claim 1, further comprising generating advertisement performance data from the average treatment effect.

3. The method of claim 1, wherein matching each customer is performed using one or more of propensity matching, inverse probability weighting, optimal matching using linear sum assignment, survival matching and double machine learning.

4. The method of claim 1, wherein matching each customer is performed using one or more of impression counts, time independent; path dependent; and path and time dependent processes.

5. The method of claim 1, further comprising measuring an incremental causal impact of an ad campaign.

6. The method of claim 1, further comprising measuring backlash.

7. The method of claim 1, further comprising measuring diminishing return effects and memory decay effects.

8. The method of claim 1, further comprising tracking one or more of a customer ID and a cookie ID.

9. The method of claim 1, further comprising determining a total number of impressions a user was exposed to in a time frame.

10. The method of claim 9, further comprising determining whether a user converted in the time frame.

11. The method of claim 9, further comprising determining a list of campaign codes that a user was exposed to in the time frame in chronological order.

12. The method of claim 9, further comprising determining timestamps of an user journey in the time frame, a list of timestamps for ad exposures associated with a campaign ID.

13. The method of claim 12, further comprising determining a subset of campaign codes that occurred prior to a conversion.

14. The method of claim 1, further comprising determining a subset of a list of timestamps for ad exposures prior to conversion.
